(19) United States
(12) Patent Application Publication
(10) Pub. No.: US 2017/0313731 A1
(43) Pub. Date: Nov. 2, 2017

(54) PROCESS FOR PRODUCING METHYLDICHLOROPHOSPHANE

(71) Applicant: BAYER CROPSCIENCE AKTIENGESELLSCHAFT, MONHEIM AM RHEIN (DE)

(72) Inventors: HANS-JOACHIM RESSEL, HATTERSHEIIM (DE); MARK JAMES FORD, WIESBADEN-BRECKENHEIM (DE); Tim HAMMERER, Köln (DE); Aurel WOLF, Wülfrath (DE)

(73) Assignee: BAYER CROPSCIENCE AKTIENGESELLSCHAFT, MONHEIM AM RHEIN (DE)

(21) Appl. No.: 15/528,426

(22) PCT Filed: Nov. 18, 2015
(86) PCT No.: PCT/EP2015/076921

§ 371 Date: May 19, 2017

(30) Foreign Application Priority Data
Nov. 20, 2014 (EP) 14194201.1

(51) Int. Cl. C07F 9/52; B01J 27/10; C01B 17/45

(52) U.S. Cl. CPC C07F 9/52; C01B 17/4592; B01J 27/10; C01B 17/4584

(57) ABSTRACT

The present invention primarily relates to a process for producing methyldichlorophosphane (MDP) by reaction of methane with PCl₃ (phosphorus trichloride) in the presence of a catalytically active amount of a compound of formula SOₓCl₂, wherein the index x may take the value 1 (SOCl₂, thionyl chloride) or 2 (SO₂Cl₂, sulphuryl chloride). The present invention further relates to particular mixtures that are particularly suitable for producing methyldichlorophosphane (MDP) in the context of the process according to the invention/that are formed when carrying out a process according to the invention.

The present invention primarily relates to a process for producing methyldichlorophosphane (MDP) by reaction of methane with PCl₃ (phosphorus trichloride) in the presence of a catalytically active amount of a compound of formula SOₓCl₂, wherein the index x may take the value 1 (SOCl₂, thionyl chloride) or 2 (SO₂Cl₂, sulphuryl chloride). The present invention further relates to particular mixtures that are particularly suitable for producing methyldichlorophosphane (MDP) in the context of the process according to the invention/that are formed when carrying out a process according to the invention.

Processes for producing methyldichlorophosphane (CH₃PCl₂) or structurally similar compounds are known from the prior art.

EP 0999216 A2 describes a process for producing aliphatic alkyldihalophosphanes by reaction of an aliphatic hydrocarbon with a phosphorus trihalide, wherein the reaction is initiated photochemically with a UV excimer radiation source.

U.S. Pat. No. 2,137,792 relates to the reaction of alkanes having more than 5 carbon atoms with phosphorus trichloride using aluminium trichloride to afford the corresponding alkyldihalophosphane-aluminium trichloride complexes from which the corresponding alkyldihalophosphane may subsequently be liberated.

U.S. Pat. No. 3,210,418 describes the synthesis of alkyldihalophosphanes by reaction of alkanes with phosphorus trihalides in the presence of catalytic amounts of atmospheric oxygen as an initiator.

U.S. Pat. No. 3,709,932 describes a process for conversion of alkanes with phosphorus trihalides to afford alkyldihalophosphanes in the presence of catalytic amounts of phosgene.

U.S. Pat. No. 3,974,217 discloses a process for synthesizing substituted phenylphosphorus dihalides by reaction of substituted phenylene with phosphorus trihalides in the presence of catalytic amounts of tin tetrachloride or titanium tetrachloride.

U.S. Pat. No. 4,101,573 and DE 2629299 describe a process for producing methyldichlorophosphane by reaction of methane with phosphorus trichloride in the presence of 2 to 7 mol % of carbon tetrachloride based on the employed phosphorus trichloride, wherein at constant residence times of 0.1 to 0.9 seconds the carbon tetrachloride employed is reacted to an extent of 50% to 80% by varying the reaction temperature between 550° C. and 650° C.

J. Org. Chem. 1974, 39, 1303-1306 describes the free-radical chlorination of alkanes with thionyl chloride.

EP 0082350 A1 relates to the production of methyldichlorophosphane by reaction of methane with phosphorus trichloride in the presence of 2 to 7 mol % of carbon tetrachloride based on the employed phosphorus trichloride at temperatures of 500° C. to 650° C. and a residence time of 0.1 to 0.9 seconds, wherein the reaction is carried out at a pressure of 2 to 10 bar and the amount of carbon tetrachloride added is reduced with increasing pressure.

The recovery and purification of methyldichlorophosphane from reaction mixtures resulting from reaction of methane with phosphorus trichloride in the presence of carbon tetrachloride is described in U.S. Pat. No. 4,101,299 for example.

Production of MDP from PCl₃ and methane (CH₄) via a homogeneous gas-phase reaction often employs carbon tetrachloride (CCl₄) as catalyst. The use of CCl₄ has several disadvantages: CCl₄ is highly toxic and a greenhouse gas and its use in the production of MOP results in the formation of deposits in the reactor and necessitates regular cleaning of the reactor.

It was a primary object of the present invention to find an alternative to the use of carbon tetrachloride in the process for producing MDP from PCl₃ and methane.

This alternative process should preferably make it possible to avoid some if not all of the abovedescribed disadvantages associated with the use of carbon tetrachloride. This alternative process shall further make it possible to achieve yields of MDP that are comparable or improved compared to the process for producing MDP in the presence of carbon tetrachloride.

This object is achieved in accordance with the invention by the use of SOCl₂ (thionyl chloride)/SO₂Cl₂ (sulphuryl chloride) in the reaction of methane with phosphorus trichloride.

The invention thus primarily relates to a process for producing methyldichlorophosphane by reaction of methane with phosphorus trichloride, characterized in that the reaction is carried out in the presence of a compound of formula SOₓCl₂, wherein x is 1 or 2.

The process according to the invention may be depicted schematically as follows, wherein the index x may take the values 1 (one) or 2 (two).

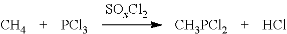

The process according to the invention is preferably carried out in the presence of a catalytically active amount of a compound of formula SOₓCl₂, wherein x is 1 or 2.

The process according to the invention is preferably carried out in the presence of a catalytically active amount of thionyl chloride and/or sulphuryl chloride.

In the process according to the invention the total amount of SOₓCl₂ is preferably in the range from 0.1 to 10 mol %, by preference in the range from 0.5 to 9 mol %, more preferably in the range from 1 to 8 mol %, particularly preferably in the range from 2 to 8 mol % and very particularly preferably in the range from 3 to 7 mol % in each case based on the amount of PCl₃ employed.

The process according to the invention is preferably carried out at a temperature in the range from 400° C. to 750° C., by preference at a temperature in the range from 420° C. to 700° C., particularly preferably at a temperature in the range from 450° C. to 650° C.

In the process according to the invention the molar ratio (mol/mol) of CH₄ to PCl₃ is preferably in the range from 12:1 to 2:1, preferably in the range from 10:1 to 3:1 and particularly preferably in the range from 8:1 to 4:1.

The process according to the invention is preferably carried out at a reaction pressure in the range from 500 mbar and 25 bar, by preference at a reaction pressure in the range from 700 mbar and 12 bar, more preferably at a reaction pressure in the range from 900 mbar and 10 bar.

The process according to the invention is preferably carried out such that the reaction of CH₄ and PCl₃ to afford MDP is effected in a gas-phase reaction.

The process according to the invention is preferably carried out such that a homogeneous mixture comprising CH₄, PCl₃ and SOₓCl₂ is reacted to afford MDP in a gas-phase reaction.

The average residence time of the reaction constituents CH₄, PCl₃ and SOₓCl₂, preferably of the homogeneous mixture of CH₄, PCl₃ and SOₓCl₂, in the reaction space is preferably in the range from 0.05 to 60 seconds, by preference in the range from 0.1 to 10 seconds, more preferably in the range from 0.5 to 5 seconds.

The process according to the invention is preferably carried out such that CH₄, PCl₃ and SOₓCl₂ are reacted in a flow tube preferably in the amounts (ratios) identified as preferable/particularly preferable hereinabove or hereinbelow.

Provided that CH₄, PCl₃ and SOₓCl₂ are reacted in a flow tube, said flow tube preferably has a diameter of at least 5 mm, by preference a diameter of at least 8 mm.

Provided that CH₄, PCl₃ and SOₓCl₂ are reacted in a flow tube, said flow tube preferably has a length of at least 10 cm, by preference a length of at least 15 cm.

Provided that CH₄, PCl₃ and SOₓCl₂ are reacted in a flow tube, in a further preferred embodiment said flow tube preferably has a length of at least 100 cm, by preference a length of at least 150 cm.

The process according to the invention preferably employs SO₂Cl₂ (sulfuryl chloride) or a mixture of SO₂Cl₂ (sulfuryl chloride) and SOCl₂ (thionyl chloride) as catalyst since the use of SO₂Cl₂ (sulfuryl chloride) in the process according to the invention makes it possible to achieve still higher yields of methyldichlorophosphane (MDP).

The process according to the invention is preferably carried out such that it employs no catalytically active amounts of elemental oxygen (O₂), of elemental chlorine (Cl₂), of phosgene (COCl₂), of carbon tetrachloride (CCl₄), of nitrogen oxides or of chlorohydrocarbons and preferably uses no UV excimer radiation source either.

The process according to the invention employs SOCl₂ (thionyl chloride) and/or SO₂Cl₂ (sulfuryl chloride) as catalysts and preferably employs no active amount of any further catalyst and by preference employs no further catalysts and uses no UV excimer radiation source.

In a further aspect the present invention relates to the use of a compound of formula SOₓCl₂, wherein x is 1 or 2, for producing methyldichlorophosphane (MDP), in particular in one of the embodiments of the process according to the invention for producing methyldichlorophosphane (MDP) which have been identified as preferable.

In a further aspect the present invention relates to mixtures comprising, consisting essentially of or consisting of

(i) PCl₃,

and

(ii) SOₓCl₂, wherein x has the value 1 or 2,

wherein the total amount of constituent (ii) SOₓCl₂ is preferably in the range from 0.1 to 10 mol %, by preference in the range from 0.5 to 9 mol %, more preferably in the range from 1 to 8 mol %, particularly preferably in the range from 2 to 8 mol % and very particularly preferably in the range from 3 to 7 mol % in each case based on the amount of constituent (i) PCl₃ employed.

An inventive mixture consisting essentially of (i) PCl₃ and (ii) SOₓCl₂, wherein x has the value 1 or 2, preferably refers to a mixture in which the sum of the constituents (i) and (ii) totals at least 85 wt %, preferably totals at least 90 wt % and particularly preferably totals at least 95 wt % in each case based on the overall weight of the mixture.

In a further aspect the present invention relates to mixtures comprising, consisting essentially of or consisting of

(i) PCl₃,

(ii) SOₓCl₂, wherein x has the value 1 or 2,

and

(iii) CH₄,

wherein

the molar ratio (mol/mol) of constituent (iii) CH₄ to constituent (i) PCl₃ is preferably in the range from 12:1 to 2:1, preferably in the range from 10:1 to 3:1 and particularly preferably in the range from 8:1 to 4:1.

It is preferable when the total amount of constituent (ii) SOₓCl₂ is preferably in the range from 0.1 to 10 mol %, by preference in the range from 0.5 to 9 mol %, more preferably in the range from 1 to 8 mol %, particularly preferably in the range from 2 to 8 mol % and very particularly preferably in the range from 3 to 7 mol % in each case based on the amount of constituent (i) PCl₃ employed.

An inventive mixture consisting essentially of (i) PCl₃, (ii) SOₓCl₂, wherein x has the value 1 or 2, and (iii) CH₄ preferably refers to a mixture in which the sum of the constituents (i), (ii) and (iii) totals at least 90 wt %, preferably totals at least 95 wt % and particularly preferably totals at least 98 wt % in each case based on the overall weight of the mixture.

In a further aspect the present invention relates to mixtures comprising, consisting essentially of or consisting of

(i) PCl₃,

(ii) SOₓCl₂, wherein x has the value 1 or 2,

(iii) CH₄,

and

(iv) MDP (methyldichlorophosphane).

An inventive mixture consisting essentially of (i) PCl₃, (ii) SOₓCl_{2,} wherein x has the value 1 or 2, (iii) CH₄ and (iv) MDP (methyldichlorophosphane) preferably refers to a mixture in which the sum of the constituents (i), (ii), (iii) and (iv) totals at least 80 wt %, preferably totals at least 90 wt % and particularly preferably totals at least 95 wt % in each case based on the overall weight of the mixture.

The invention is elucidated by the examples which follow.

### EXAMPLES

Methods of measurement:

Hewlett Packard gas chromatograph, column: Zebron ZB-624, 30 m×0.53 mm, 3 μm, He, 20:1 split ratio.

Detector: WLD, injection volume: 10 μl, 60° C., 5 min isothermal, 10° C./min, 230° C.

Rf (PCl₃): 11.13 min, Rf (MDP): 11.92 min.

### Example 1

A quartz tube reactor heated to 500° C. and having a diameter of 9 mm and a length of 170 mm was charged with 7.91 dm³/h of methane and 1.32 dm³/h of PCl₃ and the volumetric ratio of CH₄:PCl₃ was therefore 6:1 (v/v). Dissolved in this PCl₃ were 5 mol %, based on the amount of PCl₃ employed, of SOCl₂ (thionyl chloride) as catalyst. The liquid stream of the PCl₃ and SOCl₂ mixture were passed over a preevaporator heated to 250° C. prior to introduction into the reactor. A sample from the resulting product gas stream was conducted via condensation into a bypass cooled to −78° C. and subsequently analysed by gas chromatography (GC). The yield of MDP, based on the amount of PCl₃ employed, is reported in Table 1 which follows.

### Example 2

The production of methyldichlorophosphane (MDP) was carried out as per Example 1 with the temperature set to 550° C.

### Example 3

The production of methyldichlorophosphane (MDP) was carried out as per Example 1 with the temperature set to 600° C.

### Example 4

The production of methyldichlorophosphane (MDP) was carried out as per Example 1 with 5 mol %, based on the amount of PCl₃ employed, of SO₂Cl₂ (sulfuryl chloride) being used as catalyst.

### Example 5

The production of methyldichlorophosphane (MDP) was carried out as per Example 4 with the temperature set to 550° C.

### Example 6

The production of methyldichlorophosphane (MDP) was carried out as per Example 4 with the temperature set to 600° C.

The yield of MDP obtained, in each case based on the amount of PCl₃ employed, is reported in Table 1 which follows.

TABLE 1
Results of MDP production as per Examples 1 to 6

| Example | Catalyst | Temperature | Yield of MDP |
|---|---|---|---|
| 1 | SOCl₂ | 500° C. | 6.6% |
| 2 | SOCl₂ | 550° C. | 11.3% |
| 3 | SOCl₂ | 600° C. | 17.1% |
| 4 | SO₂Cl₂ | 500° C. | 6.4% |
| 5 | SO₂Cl₂ | 550° C. | 14.6% |
| 6 | SO₂Cl₂ | 600° C. | 24.3% |

Comparative tests with CCl₄:

Comparative examples analogous to Examples 1 to 6 were carried out, wherein methane and PCl₃ were reacted to afford MDP under the reaction conditions referred to in Examples 1 to 6 in the presence of CCl₄ instead of SOCl₂/SO₂Cl₂. The yields of MDP achieved in the presence of CCl₄ were comparable with those achieved with SO₂Cl₂ in each of Examples 4 to 6.

1. A process for producing methyldichlorophosphane (MDP) by reaction of methane (CH₄) with phosphorus trichloride (PCl₃), wherein the reaction is carried out in the presence of a compound of formula SOₓCl₂, wherein x is 1 or 2.

2. A process according to claim 1, wherein the reaction is carried out in the presence of a catalytically active amount of SOCl₂ and/or SO₂Cl₂.

3. A process according to claim 1, wherein the total amount of SOₓCl₂ is in the range from 0.1 to 10 mol % based on the amount of PCl₃ employed.

4. A process according to claim 1, wherein the total amount of SOₓCl₂ is in the range from 0.5 to 9 mol % based on the amount of PCl₃ employed.

5. A process according to claim 1, wherein the total amount of SOₓCl₂ is in the range from 2 to 8 mol % based on the amount of PCl₃ employed.

6. A process according to claim 1, wherein the total amount of SOₓCl₂ is in the range from 3 to 7 mol % based on the amount of PCl₃ employed.

7. A process according to claim 1, wherein the molar ratio of CH₄ to PCl₃ is in the range from 12:1 to 2:1.

8. A process according to claim 1, wherein the molar ratio of CH₄ to PCl₃ is in the range from 10:1 to 3:1.

9. A process according to claim 1, wherein the molar ratio of CH₄ to PCl₃ is in the range from 8:1 to 4:1.

10. A process according to claim 1, wherein the reaction is carried out at a temperature in the range from 400° C. to 750° C.

11. A process according to claim 1, wherein the reaction of CH₄ and PCl₃ to afford MDP is effected in a gas-phase reaction.

12. A product comprising a compound of formula SOₓCl₂, wherein x is 1 or 2, for producing methyldichlorophosphane (MDP).

13. A mixture comprising, or consisting essentially of or consisting of
(i) PCl₃,
and
(ii) SOₓCl₂, wherein x has the value 1 or 2,
wherein the total amount of constituent (ii) SOₓCl₂, based on the amount of constituent (i) PCl₃ employed, is optionally equal to the total amount defined in claim 3.

14. A mixture comprising, or consisting essentially of or consisting of
(i) PCl₃,
(ii) SOₓCl₂, wherein x has the value 1 or 2,
and
(iii) CH₄,
wherein
the total amount of constituent (ii) SOₓCl₂, based on the amount of constituent (i) PCl₃ employed, is optionally equal to the total amount defined in claim 3,
and/or
the molar ratio of constituent (iii) CH₄ and constituent (i) PCl₃ is optionally equal to the ratio in the range from 12:1 to 2:1.

15. A mixture comprising, or consisting essentially of or consisting of
(i) PCl₃,
(ii) SOₓCl₂, wherein x has the value 1 or 2,
(iii) CH₄,
and
(iv) MDP (methyldichlorophosphane).
